(19) United States
(12) Patent Application Publication
(10) Pub. No.: US 2006/0233586 A1
(43) Pub. Date: Oct. 19, 2006

(54) PACKING MECHANISM FOR INKJET CARTRIDGES FOR USE INSIDE OF A PRINTER

(76) Inventor: Yu-Ching Hsu, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/379,231

(22) Filed: Apr. 19, 2006

(30) Foreign Application Priority Data
Apr. 19, 2005 (TW) 094112418

(51) Int. Cl. B41J 29/02

(52) U.S. Cl. 400/691

(57) ABSTRACT

An inkjet cartridge packing mechanism having a cartridge storage box and a carrier fixer that uses the inside of a printer for storing an inkjet cartridge in order to save packing space of the printer. The packing mechanism further attaches the carrier of the printer to the carrier fixer and fixes a plurality of star wheels at the paper-feeding outlet by a flap connected to the carrier fixer, which can prevent movement of the carrier or dropping of the plurality of star wheels during transport. The saving of packing space by the packing mechanism can effectively reduce cost for transporting printers.

### BACKGROUND OF INVENTION

1. Field of the Invention

The present invention relates to a packing mechanism for inkjet cartridges, and more specifically, to a packing mechanism for inkjet cartridges for use inside of a printer.

2. Description of the Prior Art

Most multifunctional printers are sold with disposable inkjet cartridges, which are commonly packed in pulp cushioning materials, such as Styrofoam, or even by adding paper partitions. Since additional space is needed for cartridges, the size of a printer box must be enlarged—this will increase the cost of transport per single machine.

On the other hand, a carrier inside a printer is a moving part of the machine. The prior art printer fixes the carrier to one side inside the printer with a simple dowel or adhesive tape to prevent any collisions caused by the carrier. Unfortunately, the adhesive tape sometimes comes off and the simple dowel still requires extra modification on the body of the printer. Also, some printers have star rollers at the outlet of the machine, which are likely to shift or fall during transport. Thus, the prior art printers need additional modification to protect the carrier and the star rollers, or require additional expense to pay for collision damage, if no protection is provided.

### SUMMARY OF INVENTION

Therefore, the primary objective of the claimed invention is to provide a packing mechanism for inkjet cartridges for use inside of a printer to solve these problems.

The claimed invention provides a packing mechanism for inkjet cartridges for use inside of a printer. The packing mechanism comprises a carrier fixer having a plurality of slits, which allow a plurality of holders of a carrier to extend therein and fasten the carrier fixer to the carrier, and a cartridge storage box installed on the carrier fixer capable of holding an inkjet cartridge.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a front view of the present invention packing mechanism for inkjet cartridges.

FIG. 2 illustrates a rear view of the packing mechanism for inkjet cartridges in FIG. 1.

FIG. 3 illustrates how a carrier fixer attaches to a carrier.

FIG. 4 is an illustration of part of the packing mechanism including a main flap, an auxiliary supporting flap and a tab.

FIG. 5 illustrates how the main flap and the auxiliary supporting flap in FIG. 4 are inserted into a first and a second opening, respectively.

### DETAILED DESCRIPTION

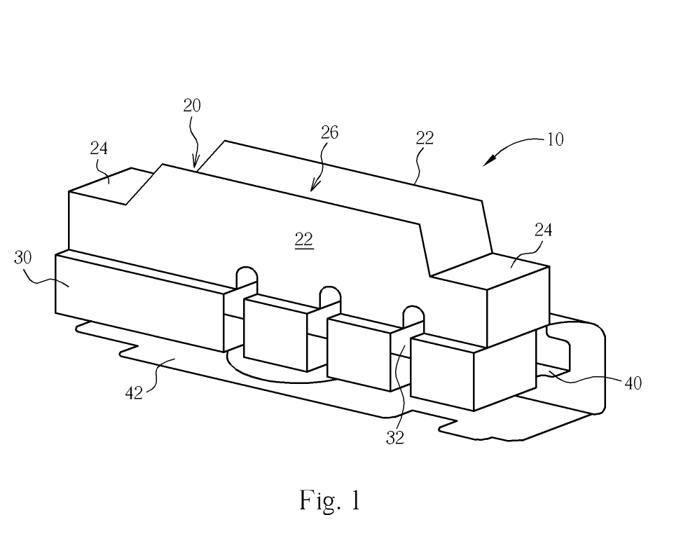

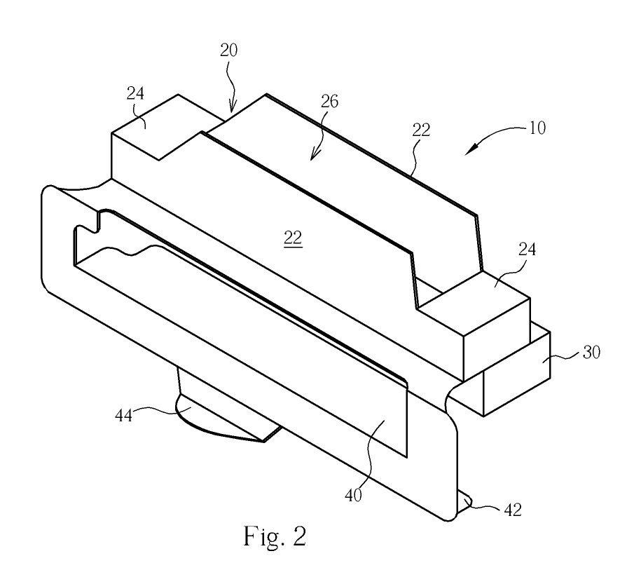

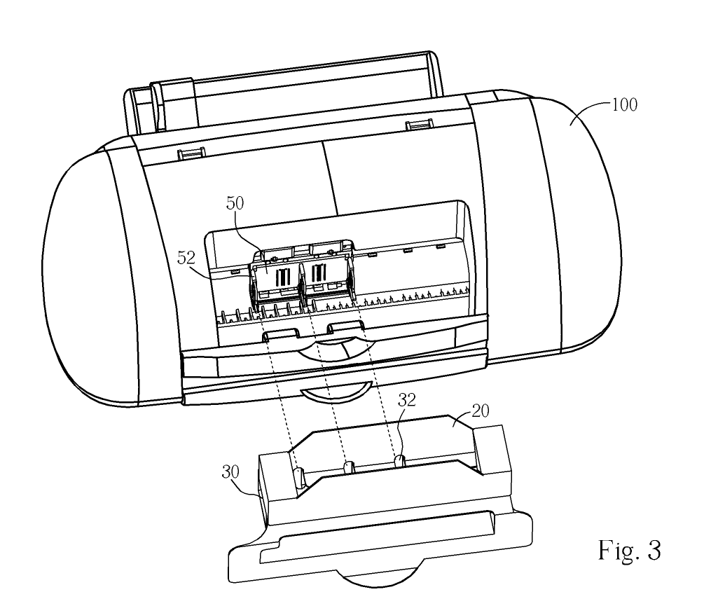

Please refer to FIG. 1 and FIG. 2. FIG. 1 illustrates a front view of the present invention packing mechanism 10 for inkjet cartridges. FIG. 2 illustrates a rear view of the packing mechanism 10 in FIG. 1. The packing mechanism 10 comprises a cartridge storage box 20, a carrier fixer 30, a main flap 40, an auxiliary supporting flap 42 and a tab 44. Please refer to FIG. 3 together with FIG. 1 and FIG. 2. FIG. 3 illustrates how a carrier fixer attaches to a carrier. The carrier fixer 30 comprises a plurality of slits 32 for allowing a plurality of holders 52 of a carrier 50 in a printer 100 to extend therein and fasten the carrier fixer 30 to the carrier 50. The cartridge storage box 20 is installed on the carrier fixer 30 for holding an inkjet cartridge.

The carrier fixer 30 is a rectangular tube. The space between each adjacent pair of the plurality of slits 32 on the carrier fixer 30 equals to the distance between each adjacent pair of the holders 52 on the carrier 50. If the printer 100 is a color printer 100 and the carrier 50 is capable of installing two cartridges, then there should be three holders 52 that lead to three corresponding slits 32 set up on the carrier fixer 30. During the packing stage of manufacturing of the printer 100, the carrier 50 is placed in order for the plurality of holders 52 of the carrier 50 to extend into the plurality of slits 32 of the carrier fixer 32. Since, once they are inside the slits 32, there is no room for the holders 52 of the carrier 50 to move, and the carrier 50 is restricted from sliding around in the printer 100 during transport, which prevents unexpected damage of the carrier 50.

Please refer to FIG. 1 and FIG. 2 again. The cartridge storage box 20 of the present invention packing mechanism 10 is installed above the carrier fixer 30. Except for the space taken up by the carrier 50, which has been fixed by the carrier fixer 30 of the packing mechanism 10, there is still some space inside the printer 100. Therefore, the cartridge storage box 20 above the carrier fixer 30 can be used for holding some unused cartridges, which will save more packing space. The cartridge storage box 20 is an open box where a space 26 is formed between two plates 22 and two caps 24 for holding the cartridges. The space 26 has a proper size for holding the cartridges; the plates 22 and the caps 24 can tightly enclose the cartridges. Thus the cartridges will not collide with other parts inside the printer 100 during transport.

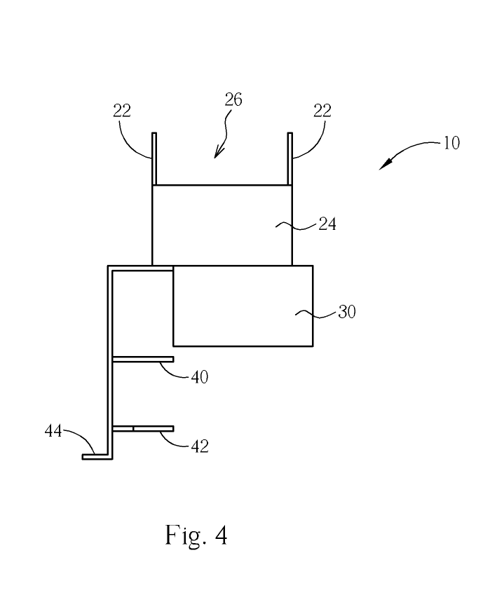

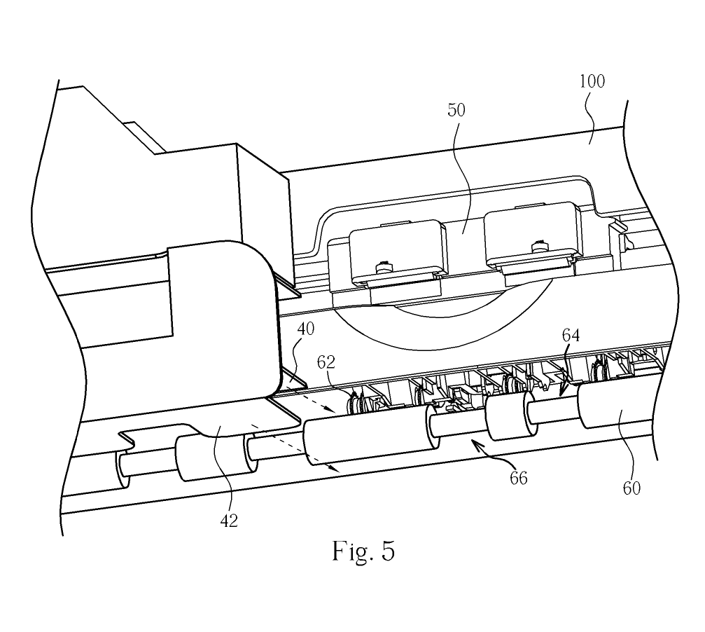

Please refer to FIG. 4 and FIG. 5. FIG. 4 is an illustration of part of the packing mechanism 10 including a main flap 40, an auxiliary supporting flap 42 and a tab 44. FIG. 5 illustrates how the main flap 40 and the auxiliary supporting flap 42 in FIG. 4 are inserted into a first opening 64 and a second opening 66 respectively. The packing mechanism 10 further has a main flap 40 connected outside to the carrier fixer 30 for insertion into the first opening 64, between a plurality of rollers 60 and a plurality of star rollers 62, for stabilizing the plurality of star rollers 62. The plurality of rollers 60 and the plurality of star rollers 62 are for moving the paper out of the printer 100. The paper moves out from the first opening 64 with the printing surface facing up. Therefore, the plurality of rollers 60 under the first opening 64 are high friction rollers 64, while the plurality of star rollers 62 above the first opening 64, when lowered onto the printing paper, contact least possible surface area of the paper, due to the star shape of the star rollers 62. The plurality of star rollers 62 are linked successively by springs, which in turn rest upon a holder of the first opening 64, and thus the star rollers 62 are likely to shift or fall during transport. The main flap 40 of the present invention, when inserted into the first opening 64 between the plurality of rollers 60 and the plurality of star rollers 62, can effectively stabilize the plurality of star rollers 62, solving the problem of shifting or falling of the star rollers 62.

Additionally, to give more strength to the main flap 40 of the present invention packing mechanism 10, the auxiliary supporting flap 42 is further connected to the main flap 40, where the auxiliary supporting flap 42 is for insertion into the second opening 66 of the printer 100 for pressing the packing mechanism 10 close to the printer 100. The packing mechanism 10 further comprises a tab 44 connected to the auxiliary supporting flap 42 for pulling the main flap 40 and the auxiliary supporting flap 42 when the tab 44 is pulled. The main flap 40 and the auxiliary supporting flap 42 are inserted into the first opening 64 and the second opening 66 of the printer 100, respectively. After purchasing the printer 100, a user can use the tab 44 to easily pull the whole packing mechanism 10 out of the printer 100. That is, the tab 44 helps the user to dismount the packing mechanism 10.

The present invention packing mechanism 10 uses the cartridge storage box 20, the carrier fixer 30 and the main flap 40 for fully utilizing the space inside of the printer 100. Holding cartridges in this way saves more space for packing. Meanwhile, the carrier 50 and the star rollers 62 at the outlet can be stabilized, preventing collision during transport, which solves the problem of the prior art remarkably. The packing mechanism 10 can be made of cardboard, plastic, or other suitable materials, with a single piece or multiple pieces. The packing mechanism 100 can be applied not only to a printer 100 but also any multifunctional machine that has a function similar to the printer 100.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A packing mechanism for inkjet cartridges for use inside of a printer comprising:
a carrier fixer having a plurality of slits which allow a plurality of holders of a carrier to extend therein and fasten the carrier fixer to the carrier; and
a cartridge storage box installed on the carrier fixer capable of holding an inkjet cartridge.

2. The packing mechanism of claim 1 further comprising a main flap connected to the carrier fixer and inserted into an opening between a plurality of rollers and a plurality of star rollers for fixing the plurality of star rollers.

3. The packing mechanism of claim 2 further comprising an auxiliary supporting flap connected to the main flap and inserted into another opening of the printer for pressing the packing mechanism close to the printer.

4. The packing mechanism of claim 3 further comprising a tab connected to the auxiliary supporting flap for pulling the main flap and the auxiliary supporting flap when the tab is pulled.

5. The packing mechanism of claim 1 wherein the packing mechanism is made of cardboard.
